(19) United States
(12) Patent Application Publication
(10) Pub. No.: US 2020/0363214 A1
(43) Pub. Date: Nov. 19, 2020

(54) METHOD FOR USING A FEATURE-BASED LOCALIZATION MAP FOR A VEHICLE

(71) Applicant: Robert Bosch GmbH, Stuttgart (DE)

(72) Inventors: Roland Langhans, Stuttgart (DE); Daniel Zaum, Sarstedt (DE); Jan Rohde, Stuttgart (DE)

(21) Appl. No.: 16/857,704

(22) Filed: Apr. 24, 2020

(30) Foreign Application Priority Data
May 17, 2019 (DE) 102019207215.1

(51) Int. Cl. G01C 21/30; G01C 21/36

(52) U.S. Cl. CPC G01C 21/30; G01C 21/36

(57) ABSTRACT

A method for using a feature-based localization map for a vehicle. The method includes: providing sensor detection data; a) providing map data of the feature-based localization map; b) ascertaining a defined deviation between the sensor detection data and the map data; c) performing an evaluation of the map data; and d) providing a result of the evaluation.

### CROSS REFERENCE

The present application claims the benefit under 35 U.S.C. § 119 of German Patent Application No. DE 102019207215.1 filed on May 17, 2019, which is expressly incorporated herein by reference in its entirety.

### FIELD

The present invention relates to a method for using a feature-based localization map for a vehicle. The present invention furthermore relates to a device for using a feature-based localization map for a vehicle. The present invention furthermore relates to a computer program. The present invention furthermore relates to a machine-readable storage medium.

### BACKGROUND INFORMATION

Localization systems having feature-based digital localization maps for determining vehicle position and vehicle orientation are central system components of automated driving functions.

German Patent Application No. DE 10 2017 004 721 A1 describes a method and an associated system for localizing a vehicle, the surroundings data of a vehicle surroundings being detected by a vehicle sensor system and being correlated with information from a digital surroundings map, and the position of the vehicle in the surroundings map being determined on the basis of a result of the correlation.

German Patent Application No. DE 10 2016 210 495 A1 describes a method for producing an optimized localization map for a vehicle, in which data of a radar satellite are used.

German Patent Application No. DE 10 2016 212 774 A1 describes a method and a device for producing a surroundings map and for localizing a vehicle.

### SUMMARY

It is an object of the present invention to provide an improved method for using a feature-based localization map for a vehicle.

According to a first aspect of the present invention, the object may be attained by an example method in accordance with the present invention for using a feature-based localization map for a vehicle, including the steps:
a) providing sensor detection data;
b) providing map data of the feature-based localization map;
c) ascertaining a defined deviation between the sensor detection data and the map data;
d) performing an evaluation of the map data; and
e) providing a result of the evaluation.

In this manner it is advantageously possible to detect errors in a localization system of a vehicle, which are caused by an inaccurate feature-based localization map. Ultimately, an evaluation of the localization map is performed in this manner in contrast to providing a “robust map” in accordance with the related art. In this manner, a portion of safety-related ASIL measures is implemented, errors that occur in the generation of the localization map being prevented from propagating through the entire vehicle system. It is assumed in this instance that the sensor detection data are less encumbered by errors than data of the feature-based localization map.

According to a second aspect of the present invention, the object may be achieved by an example device in accordance with the present invention for using a feature-based localization map for a vehicle, which is designed to implement a provided method for using a feature-based localization map for a vehicle.

According to a third aspect of the present invention, the object may be achieved by an example computer program in accordance with the present invention, comprising commands that prompt a computer, when executing the computer program, to implement a provided method.

According to a fourth aspect of the present invention, the object may be achieved by an example machine-readable storage medium, on which the computer program is stored.

Advantageous developments of the example method and device in accordance with the present invention are described herein.

An advantageous development of the example method provides for a similarity value between the mutually aligned map data and the sensor detection data to be determined in step d). In this manner, it is ascertained whether the sensor detection data match the map data.

A further advantageous development of the example method provides for the similarity value between the mutually aligned map data and the sensor detection data to be ascertained using a similarity metric or using an approach for machine learning (e.g., with the aid of neural networks). Advantageously, different methods are thereby provided for ascertaining a similarity value, parameters and limiting values for the similarity metric being preferably ascertained from test runs.

A further advantageous development of the example method provides for the Hausdorff metric to be used as the similarity metric or for using an ascertainment of a quadratic error between the map data and the sensor detection data.

Advantageously, different methods are thereby provided for determining a defined similarity between the map data and the sensor detection data. The evaluation of multiple similarity metrics increases the probability of the detection of deviations. The interpretation of different combinations of similarity values may be performed via a machine learning approach.

Another advantageous development of the example method provides for a status of the feature-based localization map to be provided in step e). In this manner, it is possible to use the feature-based localization map based on the status of the map data. This advantageously improves a usability or usefulness of the map data.

Another advantageous development of the example method provides for the feature-based localization map not to be used or to be used only with reservations for localizing the vehicle in the event of a negative map status. In this manner, it is possible for example to perform the localization of the vehicle by using odometry data in order to estimate in this manner a position of the vehicle. It is furthermore also possible to continue to use the map data of the localization map in the knowledge that the localization using the map data is not trustworthy or trustworthy only to a limited extent. This information may be very valuable for higher-ranking subsequent functions of the vehicle such as, e.g., a freeway assistant.

Another advantageous development of the method provides, in step b), for the map data to be transmitted to the vehicle via a radio-based interface, respectively section-by-section according to the travel route of the vehicle. It is thus possible to transmit the map data section-by-section to the vehicle, which helps to ensure that the map data in the vehicle are highly up to date and which advantageously limits a data quantity of the map data to be transmitted.

Another advantageous development of the example method provides for ascertaining a time sequence of evaluation results of the feature-based localization map. This may be used as additional useful information, from which it is possible to infer for example how map errors develop.

Further measures improving the present invention are presented in greater detail below with reference to the figures together with the description of preferred exemplary embodiments of the present invention.

### BRIEF DESCRIPTION OF THE DRAWINGS

FIG. 1 shows a system diagram representing a conventional method for using a feature-based localization map for a vehicle.

FIG. 2 shows a diagram representing in principle a problem of an outdated feature-based localization map.

FIG. 3 shows a system diagram representing a conventional method for using a feature-based localization map for a vehicle.

FIG. 4 shows a fundamental sequence of a provided method for using a feature-based localization map for a vehicle.

### DETAILED DESCRIPTION OF EXAMPLE EMBODIMENTS

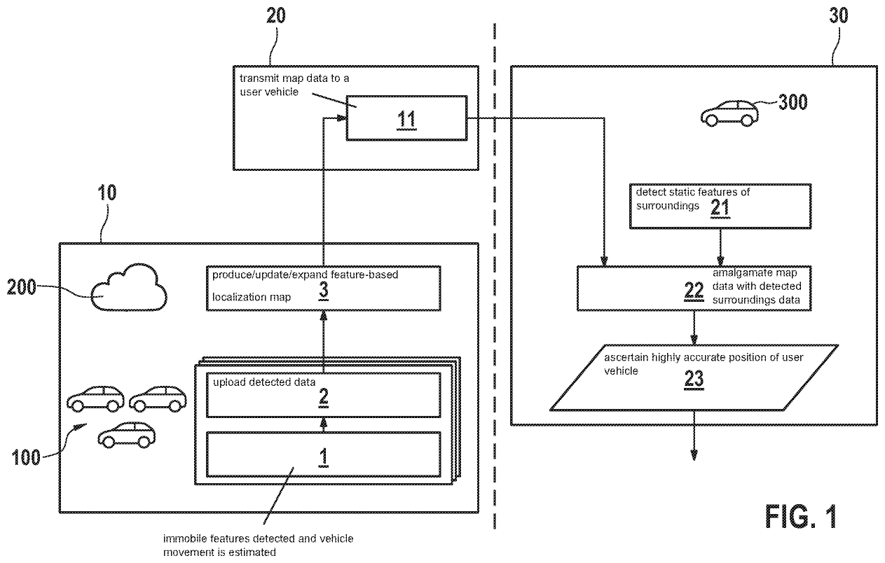

FIG. 1 shows a fundamental system diagram of a conventional method of using a feature-based localization map for a vehicle, in particular for an automated vehicle. The operation of automated driving functions is normally regulated by high or stringent demands on functional safety. These high demands also apply to the localization system of the vehicle. Next to current sensor measurements, feature-based localization maps are the most important input signals of feature-based localization systems. In modern sensor systems, there are many examples of sensors that fulfill functional safety requirements (e.g., ASIL according to ISO 26262 concerning clearly defined safety objectives).

For various reasons, such as, e.g., possibly outdated maps (changed surroundings, map remains unchanged), it not being possible to perform a map update in real time, e.g., for economic reasons etc., it is not possible to generate a map signal of sufficient integrity even when maps have been generated without errors.

The present invention provides a procedure for checking the feature-based localization map on the vehicle side.

FIG. 1 shows an example generating device 10, static, i.e., immobile features of the surroundings (static perception) being detected and a vehicle movement being estimated using mapping vehicles 100 of a vehicle fleet (step 1). In a step 2, the data detected in this manner are uploaded to the cloud, where in a step 3 the feature-based localization map is produced and/or updated and/or expanded, using a powerful electronic computing device for example.

In a step 11, a transmitting device 20 transmits map data to a user vehicle 300 via radio communication. This may occur for example section by section for the travel route, so that in each case up-to-date map data are transmitted to user vehicle 300 for subsections of a travel route.

An example map device 30 is implemented in user vehicle 300, in which static features of the surroundings are detected in a step 21. A feature-based localization map is thereby made available to a user vehicle 300 in electronic form and may be used by user vehicle 300 in a conventional manner. For this purpose, in a step 21, user vehicle 300 detects static surroundings data (e.g., buildings, traffic signs, infrastructure objects, etc.) using at least one sensor (e.g., radar sensor, lidar sensor, ultrasonic sensor, camera, etc.) and performs an estimation of a vehicle movement. In a step 23, a highly accurate position of user vehicle 300 is ascertained by cooperation with map data of the feature-based localization map.

For this purpose, in a step 22, the map data are amalgamated with the detected surroundings data and a position and an orientation (“vehicle pose”) of user vehicle 300 are ascertained in an output step 23. In a subsequent step, the mentioned data may be passed on, e.g., to a higher-order function (e.g., to an automated driving function).

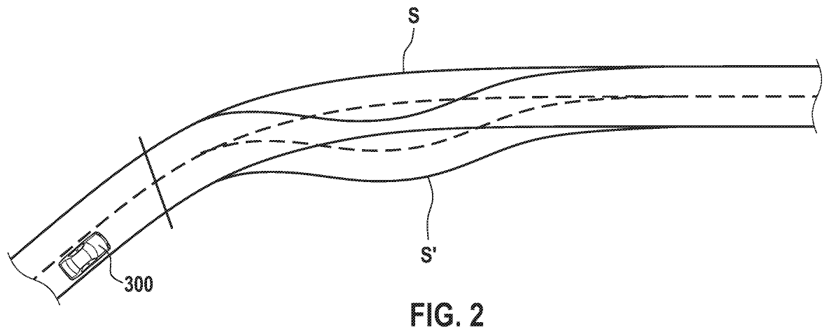

There is thus no provision in the conventional map device 30 for checking the map data of the feature-based localization map for up-to-dateness/usefulness/usablity etc. so that problems may occur in the case of an outdated feature-based localization map, as shown below with reference to FIG. 2.

FIG. 2 indicates that a user vehicle 300 locates or localizes itself in the surroundings by using a feature-based localization map. Due to a change in the surroundings, for example due to a construction site, a routing of the road S′ has changed. As a result, it is no longer possible to perform an exact localization of user vehicle 300 using the feature-based localization map since the feature-based localization map is designed for the original road route S and was not adapted to the modified road route S′.

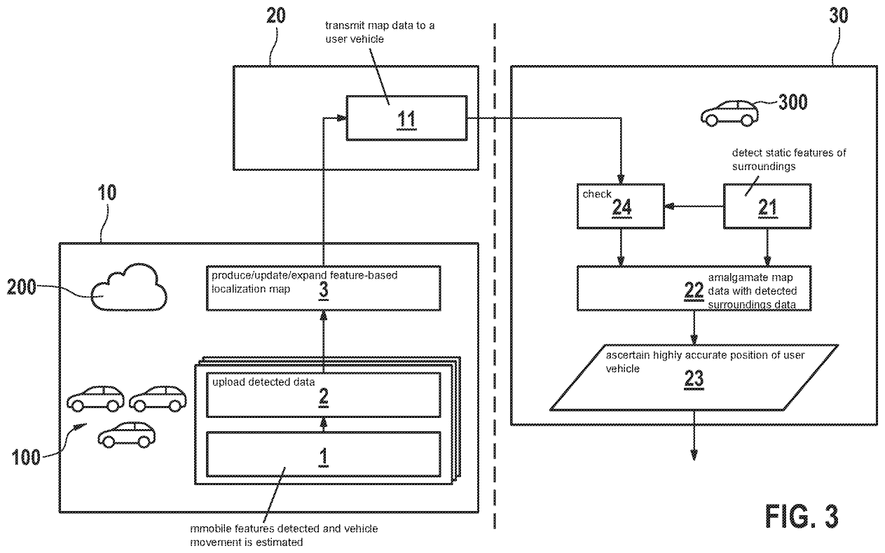

The present invention provides for a checking process, which is shown in principle in the overview diagram of FIG. 3. FIG. 3 shows essentially the same conventional system configuration as FIG. 1.

FIG. 3 shows an additional step 24, however, which represents a check step and in which the map data, which were previously transmitted to user vehicle 300 on the basis of radio communication, are checked against the sensorially detected static surroundings features for correctness or for a defined degree of agreement. For this purpose, a similarity metric is calculated and/or a quadratic error is ascertained between the mentioned data. Furthermore, it is also possible to use a previously trained neural network for this purpose. Only afterward, in step 22, are the map data checked in this manner amalgamated with the static sensor detection data.

Ultimately, in a step 23, a position of the vehicle together with its orientation and furthermore status information regarding the map data of the feature-based localization map are output for further use in a downstream system.

Multiple possibilities are possible for using the map status of the feature-based localization map. There may be a provision for example to continue to use the map data in user vehicle 300, but with the reservation of a reduced or low status.

Furthermore, there may also be a provision to deactivate and not to use the map data of the feature-based localization map due to the ascertained status so that user vehicle 300 locates itself for a certain time exclusively on the basis of odometry data (e.g., steering angle, braking data, rotational speed data, etc.).

In this manner, the provided method supports a reliable vehicle localization. In particular, a suitable system architecture having a map monitoring device is provided for this purpose. Up-to-date sensor detection data are compared with data of the provided feature-based localization map. If both signals are consistent, or are in agreement to a defined extent, the current vehicle position estimate is output together with a corresponding status message.

The provided system thus comprises the following steps:

The vehicle-side localization system is provided with a feature-based localization map (map signal) via a wireless communication interface. The localization system must satisfy the requirements of functional safety (e.g., according to ASIL), the map signal per se not satisfying any safety requirements.

The monitoring may be achieved by at least two advantageous system designs:

The considered segment from the localization map is superimposed on the sensor data provided for monitoring the localization map (with ASIL). Based on the similarity metric, the degree of agreement between the two data sets (map data, sensor data) is determined. If the degree of agreement is too low, the status of the localization system is set, e.g., to “localization map outdated.” In this manner it is possible to achieve a safe behavior of the localization system in the sense of an ASIL equivalent.

In another advantageous variant, the previously used classical similarity metric (e.g., in the form of a Hausdorff metric) may be replaced by a machine learning approach (e.g., neural network) or may be complemented or replaced by ascertaining a quadratic error between the map data and the sensor data.

As a complement to the evaluation of a similarity metric at a defined point in time, it is also possible to consider sequences over time of evaluation results in order to increase a detection rate of map errors and/or thereby to obtain a history of the localization map.

One advantage of the provided method is in particular a provision of a vehicle localization by providing prescribed safety aspects (e.g., according to ASIL) on the basis of a feature-based localization map without safety certification. Furthermore, even in non-safety-related localization systems, an early detection of localization errors is also able to influence advantageously the integrity of the output signal and thus to improve a localization of the vehicle.

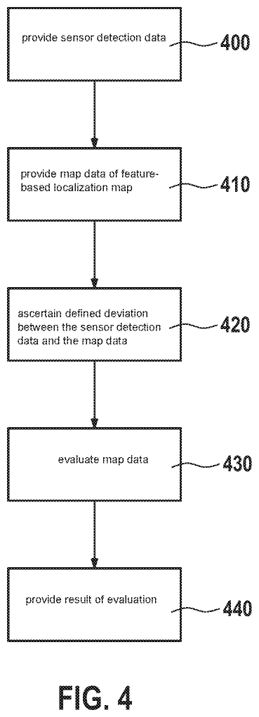

FIG. 4 shows a fundamental sequence of a provided method for using a feature-based localization map for a vehicle.

Sensor detection data are provided in a step 400.

In a step 410, map data of the feature-based localization map are provided.

In a step 420, a defined deviation is ascertained between the sensor detection data and the map data.

In a step 430, the map data are evaluated.

A result of the evaluation is provided in a step 440.

It is advantageously possible to implement step 24 of map device 30 in software, which supports an efficient and easy adaptability of the method.

When implementing the present invention, one skilled in the art will also produce specific embodiments that are not explained above.

What is claimed is:

1. A method for using a feature-based localization map for a vehicle, comprising the following steps:
a) providing sensor detection data;
b) providing map data of the feature-based localization map;
c) ascertaining a defined deviation between the sensor detection data and the map data;
d) performing an evaluation of the map data; and
e) providing a result of the evaluation.

2. The method as recited in claim 1, wherein a similarity value between mutually aligned map data and the sensor detection data is determined in step d).

3. The method as recited in claim 2, wherein the similarity value between the mutually aligned map data and the sensor detection data is ascertained using a similarity metric or using machine learning.

4. The method as recited in claim 3, wherein a Hausdorff metric is used as the similarity metric or an ascertainment of a quadratic error between the map data and the sensor detection data is used.

5. The method as recited in claim 1, wherein a status of the feature-based localization map is provided in step e).

6. The method as recited in claim 1, wherein the feature-based localization map is not used or is used only with reservations for localizing the vehicle in the event of a negative map status.

7. The method as recited in claim 1, wherein in step b), the map data are transmitted to the vehicle, via a radio-based interface, respectively section-by-section of the travel route of the vehicle.

8. The method as recited in claim 1, wherein a time sequence of evaluation results of the feature-based localization map is ascertained.

9. A device for using a feature-based localization map for a vehicle, the device configured to:
a) provide sensor detection data;
b) provide map data of the feature-based localization map;
c) ascertain a defined deviation between the sensor detection data and the map data;
d) perform an evaluation of the map data; and
e) provide a result of the evaluation.

10. A non-transitory machine-readable storage medium on which is stored a computer program for using a feature-based localization map for a vehicle, the computer program, when executed by a computer, causing the computer to perform the following steps:
a) providing sensor detection data;
b) providing map data of the feature-based localization map;
c) ascertaining a defined deviation between the sensor detection data and the map data;
d) performing an evaluation of the map data; and
e) providing a result of the evaluation.
